(19) United States
(12) Patent Application Publication
(10) Pub. No.: US 2009/0134632 A1
(43) Pub. Date: May 28, 2009

(54) Energy Harvesting System and Method

(75) Inventors: Terje Kvisteroy, Horten (NO); Nils Hedenstierna, Vastra Frolunda (SE)

Correspondence Address: EDELL, SHAPIRO & FINNAN, LLC, 1901 RESEARCH BOULEVARD, SUITE 400, ROCKVILLE, MD, 20850, US

(73) Assignee: Infineon Technologies SensoNor AS, Horten (NO)

(21) Appl. No.: 12/323,725

(22) Filed: Nov. 26, 2008

(30) Foreign Application Priority Data
Nov. 27, 2007 (EP) 071216515.4

(51) Int. Cl. H02K 7/18

(52) U.S. Cl. 290/1 R

(57) ABSTRACT

An energy harvesting system is arranged to harvest energy generated by a rotating tire. The system comprises a chamber holding fluid and an energy converter arranged to extract kinetic energy generated by a flow of the fluid, the flow being induced by a deformation of the chamber during the tire rotation, and further arranged to convert the kinetic energy into electrical energy. A method of harvesting energy generated by a rotating tire is also provided.

### CROSS REFERENCE TO RELATED APPLICATIONS

This application claims priority under 35 U.S.C. §119 to Application No. EP 07121615.4 filed on Nov. 27, 2007, entitled “Energy Harvesting System and Method,” the entire contents of which are hereby incorporated by reference.

### FIELD OF THE INVENTION

The present invention relates to an energy harvesting system and method.

### BACKGROUND

Systems comprising circuitry housed within or connected to vehicle tires, such as a tire pressure monitoring system (TPMS) sensor, need power for performing functions such as sensing pressure and transmitting data to a central unit of the system. Known TPMS modules are powered either by a battery, by an inductive field operated with coils or by back-scatter using RF frequencies. However, a battery has a limited lifetime, is expensive and is not environmentally friendly.

Devices that convert different types of energy obtained from a system into electrical energy are known as “energy harvesters”, and such devices attract increasing research interest today.

For example, US 2004/100100 discloses an apparatus and method for energy generation within a tire; US 2006/022555 discloses an energy harvesting system, apparatus and method; Epstein, A H: “Millimeter-scale MEMS Gas Turbine Engines”, Proceedings of ASME Turbo Expo, 16 Jun. 2003 discusses millimeter-size gas turbine engines and the underlying technical issues; and US 2007/074566 discloses power generation utilizing tire pressure changes.

Micromechanical energy harvesters with a seismic mass have problems in generating enough power for devices such as TPMS sensors, due to the low frequency (approximately 20 Hz in rotation speed and approximately <500 Hz in wheel vibration) of the vibrations and rotations in the associated tire. This low frequency makes it necessary to use a relatively large seismic mass and a complex method to transform the kinetic energy into electrical energy. A large mass increases the size of the chip and makes the device expensive. Large electrodes are necessary to achieve adequately high kinetic to electrical efficiency. Additionally, large coils are often necessary as part of the electrical AC-DC conversion (commonly referred to as a DC-DC conversion in the art). The present invention seeks to overcome the above problems.

### SUMMARY

According to the present invention there is provided an energy harvesting system arranged to harvest energy generated by a rotating tire, the system comprising: a chamber holding fluid; and an energy converter arranged to extract kinetic energy generated by a flow of the fluid, the flow being induced by a deformation of the chamber during the tire rotation, and further arranged to convert the kinetic energy into electrical energy, the system being characterized by further comprising: a mass connected to the chamber, the mass being arranged to deform the chamber via a movement of the mass.

According to the present invention there is further provided a method of harvesting energy generated by a rotating tire, the method comprising the steps of: inducing a flow of fluid that is provided in a chamber, the flow being induced by a deformation of the chamber during the tire rotation; extracting kinetic energy generated by the fluid flow; and converting the kinetic energy into electrical energy, the method being characterized in that: deformation of the chamber is caused by movement of a mass connected to the chamber.

The invention uses the whole weight and size of a mass, for example, a TPMS package (that is, the entire TPMS wheel module including its sensor) or deformations of the TPMS package to induce a flow in a volume of fluid (gas or liquid) contained by the package and extract the energy when the fluid flows through a small channel, thereby acting as a bellows. The fluid flow is induced either by the varying acceleration force working on the package (inertia) or by the package deformation (bellows function) from the resulting flattening of the tire when a part of the tire makes contact with the road. The advantage of such a method is that either the “effective seismic mass” is very large (compared with a micro electromechanical system (MEMS) silicon mass) as it consists of the complete package, or in the case of deformation, due to “flattening”, that the bellows that contains the fluid is very large compared with the area of a silicon MEMS device used to extract the energy.

The energy from the fluid flow can be extracted in several ways. A small micromechanical turbine is one option, particularly when using a liquid. Three less technically complex realizations for an energy converter employ a Helmholtz resonator, a fipple/whistle principle and a vortex shedding principle.

A fluid (a gas or a liquid is appropriate, as described further below) is used to transfer/extract forces from the inertial mass or the package deformation to an energy converter. The method of harvesting energy also enables an increase in the frequency content of the energy and makes it possible to use a smaller, less costly and lighter weight energy converter.

### BRIEF DESCRIPTION OF THE DRAWINGS

The invention will now be described in detail with reference to the accompanying drawings.

FIG. 1 shows a first example of an energy harvesting system according to the invention (“inertia” embodiment).

FIG. 2 shows a second example of an energy harvesting system according to the invention (“deformation package” embodiment).

FIGS. 3a to 3c illustrate an example of a bellows of the example of FIG. 1.

FIG. 4 shows an example of an energy harvesting system according to the invention having two nozzles.

FIG. 5 shows an example of an energy harvesting system according to the invention having two chambers.

FIGS. 6a to 6c show the basic known behavior of fluid flowing through each of a Helmholtz resonator, a vortex shedding arrangement and a fipple/whistle arrangement, respectively, which are used in accordance with the present invention.

FIG. 7 shows an example of an energy harvesting system according to the invention having a Helmholtz resonator combined with vortex shedding.

FIG. 8 shows an example of a known micromechanical turbine.

### DETAILED DESCRIPTION

FIG. 1 shows an embodiment of the invention that realize a bellows 1 that holds fluid therein and that can be deformed to enable a pumping action of the bellows 1, the bellows being deformed by an impact due to the inertia of a mass, for example including a tire pressure monitoring system (TPMS) package 2, when a tire surface 3 connects to and disconnects from a road surface 4 as it rotates. The bellows 1 is shown at different positions of the rotating tire/wheel, noted A, B, C, etc. For each wheel rotation the fluid, which in this case is preferably a gas, will flow in and out of the bellows 1 in turn.

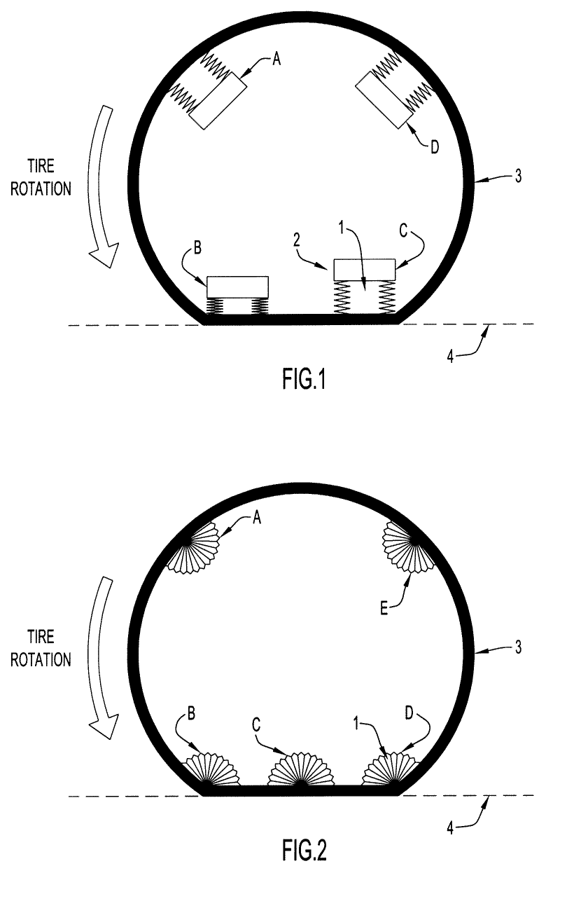

FIG. 2 shows an embodiment of the invention that realizes a bellows 1 that holds fluid therein and that can be deformed to enable a pumping action of the bellows 1, from the physical deformation of the tire, when a tire surface 3 connects to and disconnects from a road surface 4 as it rotates. The “inertia” embodiment and the “deformation package” embodiment result in exactly the same behavior of the gas flow.

Vibrations in the tire can also contribute to the deformation of the chamber.

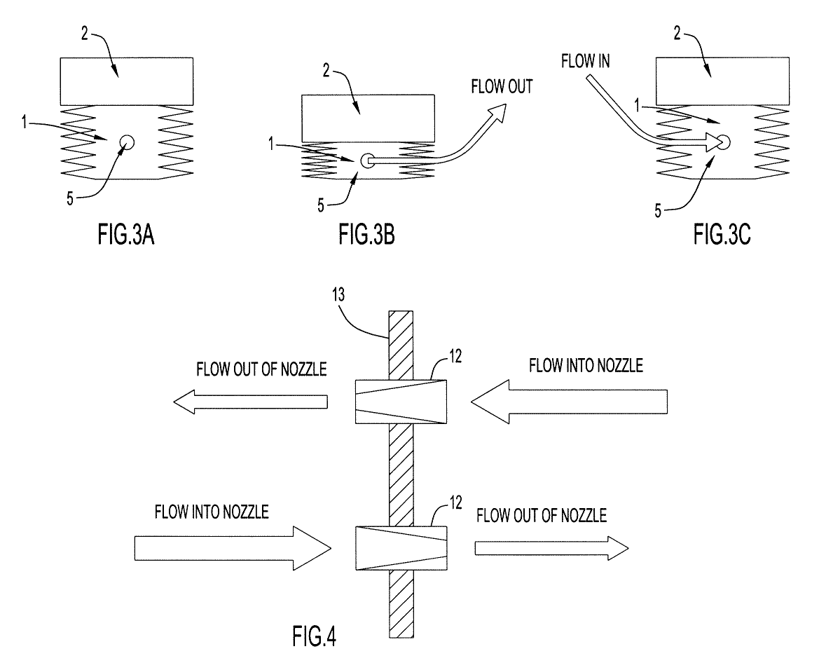

The gas flowing in and out of the bellows 1 is preferably forced through a small nozzle attached thereto. The energy converter is preferably realized as a resonant MEMS device (preferably at least one beam or blade) that intercepts the gas flow. FIG. 3 illustrates a preferred position 5 of an input/output nozzle of a bellows 1 (FIG. 3a) and illustrates the gas flow out of (FIG. 3b) and into (FIG. 3c) the bellows 1 through the nozzle. Another arrangement, shown in FIG. 4, employs two nozzles 12 connected to a wall 13 of the bellows 1, one of which is a fluid input nozzle and the other of which is a fluid output nozzle. It is also possible to employ a valve system to aid in the fluid flow into and/or out of the bellows 1.

Although FIG. 3 shows only one chamber, a further realization is to use two chambers 1 connected via the nozzle, the second chamber being of constant volume. Using two chambers, as shown in FIG. 5, isolates the system from the tire “cavity”. A connection 14 connects the bellows 1 to the cavity 15.

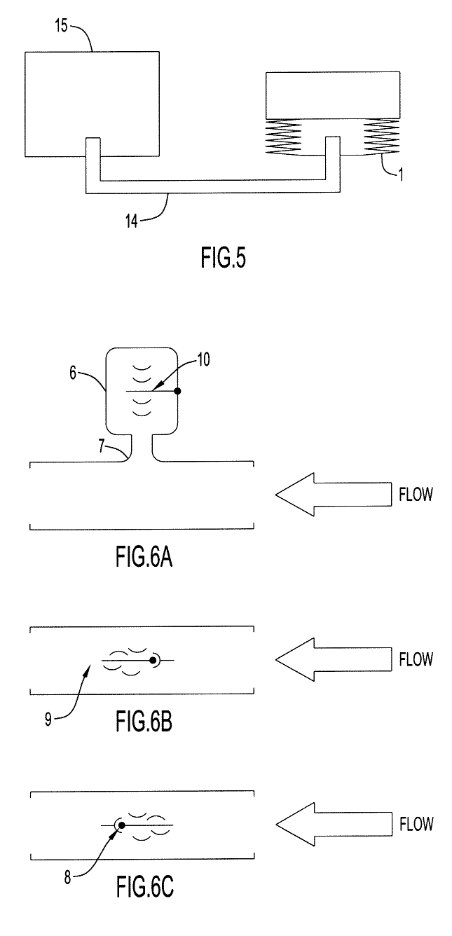

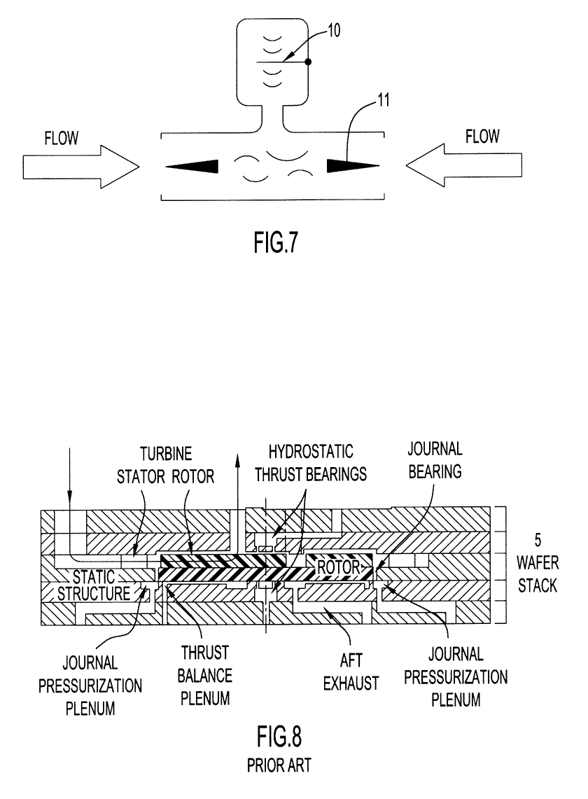

Owing to the relative dimensions of the inertial mass and the bellows, or the bellows, and the comparably small, narrow nozzle, a relatively strong gas flow is produced through the nozzle. This strong flow enables a relatively large amount of energy to be transferred to an energy converter, which preferably takes the form of a MEMS device placed in or adjacent to this gas flow. FIGS. 6a to 6c show three different realizations for an energy converter, namely a Helmholtz resonator (FIG. 6a), a vortex shedding principle (FIG. 6b) and a fipple/whistle principle (FIG. 6c), which are described further in detail below.

In one embodiment, gas vibration can be created by providing a Helmholtz resonator, as shown in FIG. 6a. A Helmholtz resonator is a container 6 of gas with an open hole (or neck or port) 7. It works by causing the “smooth” flow of gas acting on the volume of gas in and near the open hole 7 to vibrate because of the “springiness” of the air inside the container 6. One or more beams or blades 10 that vibrate at “high frequencies” (typically >20 kHz) as a result of the acoustical vibration (resonance) are provided.

A further embodiment of the invention employs the generation of vortices in the gas flow, as shown in FIG. 6c. One or more beams or blades 8 that vibrate at “high frequencies” (typically >20 kHz) in a turbulent gas flow, like a whistle, are provided. This device works by causing the “smooth” flow of gas to be split by the narrow blade 8, sometimes called a fipple, creating turbulent vortices which cause the gas to vibrate.

In a further embodiment, the above function can be realized by a bluff or barrier to split the gas flow and by positioning, for example, a cantilever blade 9 in the turbulent flow, as shown in FIG. 6b. This is known as vortex shedding. By attaching a resonant chamber to the basic “whistle” it may be tuned to a particular frequency and amplified. If no resonator is attached, the frequency will be a function of the intensity of the gas flow.

Combinations of either of the two vortex based methods and the Helmholtz resonator can also be realized.

The turbulent flow will cause, for example, a cantilever beam or blade to vibrate at a frequency dependent upon the flow rate. In the case of a Helmholtz resonator, or in the combination of vortices and a resonator chamber, the vibration will be at a tuned frequency dependent upon the geometrical shape of the resonator chamber and the neck or port. The frequency can be chosen to be much, much higher than the wheel rotation and/or vibration, since the mechanical resonance of the cantilever blade or the acoustic resonance of the Helmholtz resonator can be defined by appropriate mechanical dimensions.

In FIGS. 6a to 6c only one flow direction is shown; however, the system is typically optimized for multiple flow directions using an adjusted design or using two or more resonating elements. The Helmholtz resonator can be made direction independent and combined with vortex shedding, as illustrated in FIG. 7, using a blade shaped barrier 11.

Conversion from kinetic energy to electrical energy is achieved by using, for example, piezoelectric materials (bulk or deposited films) to form, or as a deposit onto, the vibrating cantilever beam(s) 8, 9, 10 to generate electrical power as a result of mechanical strains caused by the vibrations. Alternatively or additionally, electret materials (bulk or films) can be used for electric bias, in combination with the vibrating cantilever beam(s), where the vibrating beam and a fixed frame act as two adjacent plates establishing a varying (due to vibrations) capacitor, generating power. Alternatively or additionally, electric coils can be used for induction, in combination with the vibrating cantilever beam(s), where a magnetic material is deposited onto or constitutes the vibrating beam, the vibrations causing inductive currents in the adjacent coil, generating power.

Alternatively to a cantilever beam, a beam or blade shaped MEMS structure, having the ability to vibrate as a result of the gas flow, can be used.

As the generated frequency is ˜20 kHz, instead of the ˜20 Hz as in the tire, the electrical generator can be made much smaller (as energy =E=½mv²) than previously realized. Thus, the MEMS chip can be much smaller and more economical than a conventional energy harvester with an integrated seismic mass. Additionally if a resonant system is realized a harmonic electrical converter can be used, which is far less complex than a broad band device. A higher frequency also results in smaller and more practical capacitors and coils for the AC-DC converter.

Instead of a gas flow, a liquid flow can be used; however, in this case two chambers must be present (as shown in FIG. 5), since the liquid must be isolated from the tire “cavity”. Using a liquid lowers the operation frequency, but increases the force/moment acting upon the MEMS converter. The use of a small micromechanical turbine, a known example of which, from MIT, is shown in FIG. 8, provides a preferred system and method when using a liquid rather than a gas.

What is claimed is:

1. An energy harvesting system arranged to harvest energy generated by a rotating tire, the system comprising:
a chamber holding fluid;
a mass connected to the chamber, wherein the mass is arranged to deform the chamber via a movement of the mass; and
an energy converter configured to extract kinetic energy generated by a flow of the fluid, the flow being induced by a deformation of the chamber during the tire rotation, and further arranged to convert the kinetic energy into electrical energy.

2. The system according to claim 1, wherein the mass comprises a tire pressure monitoring system (TPMS) package.

3. The system according to claim 1, wherein the chamber is arranged to be deformed in response to a physical deformation of the tire.

4. The system according to claim 1, wherein the chamber is arranged to deform when a tire surface connects to and disconnects from an external surface as the tire rotates.

5. The system according to claim 1, wherein the chamber is arranged to be deformed in response to vibration and rotation of the tire.

6. The system according to claim 1, wherein the chamber further comprises one or more bellows, each bellows having one or more openings therein, each opening being arranged such that the fluid flows through the one or more openings as the tire rotates.

7. The system according to claim 6, wherein a nozzle is attached to one or more of the openings, such that the fluid flows through the nozzle as the tire rotates.

8. The system according to claim 1, wherein the energy converter is placed at a point of intake and/or release of the fluid from the chamber.

9. The system according to claim 1, wherein the energy converter comprises at least one of: a micromechanical turbine, a Helmholtz resonator, vortex shedding arrangement, and a fipple arrangement.

10. The system according to claim 1, wherein the energy converter comprises a micro electromechanical system (MEMS) device.

11. The system according to claim 1, wherein the energy converter comprises at least one of: a piezoelectric material, an electret material, and a magnetic material.

12. The system according to claims 1, wherein the energy converter comprises a harmonic electrical converter.

13. The system according to claim 1, wherein the energy converter comprises a MEMS blade or beam arranged to intercept a flow of the fluid as the tire rotates, such that the fluid flow causes the MEMS blade or beam to vibrate.

14. The system according to claim 1, wherein the fluid is a gas.

15. The system according to claim 1, wherein the fluid is a liquid.

16. The system according to claim 1, further comprising a second chamber of constant fluid volume.

17. A method of harvesting energy generated by a rotating tire, the method comprising:
inducing a flow of fluid that is provided in a chamber, the flow being induced by a deformation of the chamber during the tire rotation and the deformation being caused by movement of a mass connected to the chamber;
extracting kinetic energy generated by the fluid flow; and
converting the kinetic energy into electrical energy.
